(19) United States
(12) Patent Application Publication
(10) Pub. No.: US 2025/0299092 A1
(43) Pub. Date: Sep. 25, 2025

(54) PER-SAMPLE DATA DRIFT MONITORING WITH FEATURE ATTRIBUTIONS

(71) Applicant: Oracle International Corporation, Redwood Shores, CA (US)

(72) Inventors: Anatoly Yakovlev, Belmont, CA (US); Wenxin Zhang, Redwood Shores, CA (US); Sandeep Agrawal, Belmont, CA (US); Sanjay Jinturkar, Bridgewater, NJ (US); Nipun Agarwal, Redwood Shores, CA (US)

(73) Assignee: Oracle International Corporation, Redwood Shores, CA (US)

(21) Appl. No.: 18/614,302

(22) Filed: Mar. 22, 2024

(51) Int. Cl. G06N 20/00

(52) U.S. Cl. CPC G06N 20/00

(57) ABSTRACT

Systems and methods are described for efficiently determining when to retrain a machine learning model. The machine learning model is trained on a base set of data having a base set of dimensions. A data management system generates a compressed set of data by compressing data from the base set of data to a reduced set of dimensions. A base reconstruction loss is determined by comparing a decompression of the compressed set of data to the base set of data. The model makes a prediction for the base set of dimensions. The data management system generates a second compressed set of data by compressing the second set of data to the reduced set of dimensions. The data management system determines a second reconstruction loss by comparing a decompression of the second compressed set of data to the second set of data. Drift may then be determined from the reconstruction losses.

### BACKGROUND

Companies and individuals rely on software to support nearly all aspects of business and life. Much of this software automates the collection and management of data to support basic tasks, which may also be implemented in software. Software is becoming increasingly reliant on machine learning to extend functionality even when supporting information or answers to user questions are not known. Because such a variety of software depends on machine learning, machine learning and artificial intelligence, which often leverages machine learning, have become cornerstone computing technologies that are evolving independently to accommodate even more use cases.

Machine learning relies on known data values to determine value co-occurrences or other patterns among the known data values and, optionally, to predict unknown data values. Some of the known values may come from labels, which may be provided as examples of correct predictions of the unknown values. In other examples, the known values are historical data, and predictions may still be made if the prediction is based on an unknown value that occurs in a known pattern with other known values. More generally, the known data is used to train a machine learning model that may be used to predict the unknown data.

The detected patterns from one set of data or one portion of a set of data may be used to train a machine learning model to predict missing values in another set of data or another portion of the set of data. If the sets of data or portions of sets of data have similar distributions and are derived from the same or similar sources, the value co-occurrences and other patterns in one set of data should be similar to the co-occurrences and other patterns in the other set of data. The model may be validated if the model is accurate in determining missing values for the other set of data or other portion of the set of data.

A single trained machine learning model may be used and re-used to predict values for vast quantities of additional data that may even exceed the amount of data used to initially train the machine learning model. In a simple example, an initial set of data may contain the values “temperature=150 degrees” and “temperature=160 degrees” that co-occur with the value “too hot,” and the values “temperature=140 degrees” and “temperature=130 degrees” that co-occur with the value “okay.” Based on these value co-occurrences, the model may learn to classify temperatures below 140 degrees as “okay” and temperatures above 150 degrees as “too hot,” with some uncertainty about temperatures that did not occur in the initial set of data.

If the machine learning model is trained to make data-driven predictions at one point in time, then, at a later point in time, the data-driven assumptions made as part of the data-driven predictions may or may not still be valid. The model's predictions may remain accurate over time or become less and less accurate over time. In the latter scenario, the performance of software-driven decision-making may also degrade over time, resulting in lower software value. Referring to the simple example above, what once may have been considered too hot may no longer be considered too hot. Or, the model may be completely unaware that there is also a temperature that is considered “too cold.”

Retraining a model may be expensive and may include the process of re-detecting patterns in a set of data or a portion thereof and re-validating a model as effective to predict values for a different set of data or a different portion of the set of data. Retraining the model may consume computing resources for evaluating data relationships and running tests, storage resources for storing portions of the set of data, patterns detected, and a new model in addition to the existing model. Retraining a model too infrequently may result in poor model performance, and retraining the model too frequently may result in wasted resources yielding little or no model performance benefit.

### BRIEF SUMMARY

Systems and methods are described for efficiently detecting when a machine learning model should be retrained. The machine learning model is trained on a base set of data having a base set of dimensions. The data management system generates a compressed set of data by compressing data from the base set of data to a reduced set of dimensions. A base reconstruction loss is determined by comparing a decompression of the compressed set of data to the base set of data. The model makes a prediction for the base set of dimensions. The data management system generates a second compressed set of data by compressing a second set of data to the reduced set of dimensions. The data management system then determines a second reconstruction loss by comparing a decompression of the second compressed set of data to the second set of data. Drift may then be determined from the reconstruction losses.

A computer-implemented method includes storing a first set of data and a particular machine learning model. The particular machine learning model was trained using at least part of the first set of data to predict one or more values along a first set of dimensions. The first set of data includes combinations of value occurrences in the first set dimensions. The computer-implemented method further includes generating a first compressed set of data by compressing particular data from the first set of data to a second set of dimensions. The second set of dimensions has fewer dimensions than the first set of dimensions. The computer-implemented method further includes generating a first reconstructed set of data by decompressing the first compressed set of data to the first set of dimensions, and determining a first reconstruction loss between the first reconstructed set of data and the particular data based at least in part on differences between the first reconstructed set of data and the particular data along the first set of dimensions. The computer-implemented method uses the particular machine learning model to make a prediction for data along the first set of dimensions. The computer-implemented method further includes, before, after, or during the prediction, generating a second compressed set of data by compressing a second set of data to the second set of dimensions. The computer-implemented method generates a second reconstructed set of data by decompressing the second compressed set of data to the first set of dimensions, and determines a second reconstruction loss between the second reconstructed set of data and the second set of data based at least in part on differences between the second reconstructed set of data and the second set of data along the first set of dimensions. A drift difference may be determined between the first reconstruction loss and the second reconstruction loss, and the computer-implemented method further includes the drift difference in an aggregate drift difference. The computer-implemented method stores the aggregate drift difference in association with the particular machine learning model, and determines whether to retrain the particular machine learning model based at least in part on one or more conditions that are based at least in part on the aggregate drift difference.

In a further embodiment, at least a first dimension of the second set of dimensions includes a distance from a hyperplane covering a selected combination of value occurrences of the first set of data. A second dimension of the second set of dimensions is selected to be orthogonal to the first dimension.

In the same or a different embodiment, generating the first compressed set of data uses principal component analysis to compress the first set of data. Generating the second compressed set of data uses the principal component analysis to compress the second set of data.

In the same or a different embodiment, the second set of dimensions is different from the first set of dimensions. Generating the first compressed set of data uses a neural network to compress the first set of data based on one or more feature embedding vectors that describe the first set of data. Generating the second compressed set of data uses the neural network to compress the second set of data based on one or more feature embedding vectors that describe the second set of data.

In the same or a different embodiment, each dimension of the second set of dimensions is selected to account for a maximum remaining variance in the first set of data.

In the same or a different embodiment, the computer-implemented method further includes receiving a request to train a machine learning model on the first set of data. In response to the request, the computer-implemented method trains the particular machine learning model. Performing said generating the first compressed set of data, said generating the first reconstructed set of data, and determining the first reconstruction loss is performed automatically in response to training the particular machine learning model.

In the same or a different embodiment, the computer-implemented method determines, based at least in part on the aggregate drift difference, that the one or more conditions are not satisfied, and, without retraining the particular machine learning model, outputs a retraining score that indicates how close the one or more conditions are to being satisfied.

In the same or another embodiment, the computer implemented method determines, based at least in part on the aggregate drift difference, that the one or more conditions are not satisfied, and, without retraining the particular machine learning model, outputs an aggregate drift difference specific to one or more of the first set of dimensions.

In the same or a different embodiment, the computer-implemented method further includes determining, based at least in part on the aggregate drift difference, that the one or more conditions are satisfied. Based at least in part on determining that the one or more conditions are satisfied, the computer-implemented method schedules a retraining of the particular machine learning model based at least in part on a workload that uses the particular machine learning model. The particular machine learning model is retrained based at least in part on determining which particular dimensions to include from a superset of dimensions that includes the first set of dimensions and one or more other dimensions.

The drift difference may be determined synchronously or asynchronously with using the machine learning model to make a prediction for data along the first set of dimensions. In one embodiment, at least the step of determining the drift difference between the first reconstruction loss and the second reconstruction loss is performed asynchronously with using the particular machine learning model to make a prediction for data along the first set of dimensions. In another embodiment, at least the step of determining the drift difference between the first reconstruction loss and the second reconstruction loss is performed in response to a request to use the particular machine learning model to make a prediction for data along the first set of dimensions.

In various aspects, a system is provided that includes one or more data processors and a non-transitory computer-readable storage medium containing instructions which, when executed on the one or more data processors, cause the one or more data processors to perform part or all of one or more methods disclosed herein.

In various aspects, a computer-program product is provided that is tangibly embodied in a non-transitory machine-readable storage medium and that includes instructions configured to cause one or more data processors to perform part or all of one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 shows a flow chart that illustrates a process for returning a result of a prediction by a machine learning model and determining and saving a drift difference.

FIG. 2A shows a data flow during training of a machine learning model and a drift detector.

FIG. 2B shows a data flow during production using the machine learning model and the drift detector.

FIG. 3 is a system diagram showing a system for determining and indicating drift of a machine learning model.

FIG. 4 shows a flow chart illustrating a process for training a machine learning model and a drift detector.

FIG. 5 is an illustration of a user interface for displaying information about predictions and drift.

FIG. 6 depicts a simplified diagram of a distributed system for implementing certain aspects.

FIG. 7 illustrates an example computer system that may be used to implement certain aspects.

### DETAILED DESCRIPTION

Systems and methods are described for efficiently detecting when a machine learning model should be retrained. The techniques described herein involve compressing a base set of data to a reduced number of dimensions and decompressing the compressed data to determine how much data is lost for the base set of data as compared to a production set of data using the same compression and decompression technique. If the compression and decompression cause the production set of data to lose more data than the base set of data, a drift detector of the data management system may store an indication that drift is occurring in the production set of data.

In various embodiments, the drift detection techniques are implemented using non-transitory computer-readable storage media to store instructions which, when executed by one or more processors of a computer system, cause display of a user interface and processing of received input to detect and notify of drift. The drift detection techniques may be implemented on a local or cloud-based computer system that includes processors and stored instructions. The computer system may communicate with client computer systems for displaying notifications about detected drift.

A description of the drift detection techniques is provided in the following sections:
DRIFT MANAGEMENT
ENABLING MACHINE LEARNING AND TRAINING A MODEL ON DATA FROM A SET OF DATA
COMPRESSING AND DECOMPRESSING DRIFT TRAINING DATA
DETERMINING A RECONSTRUCTION LOSS
USING THE MODEL TO MAKE PREDICTIONS FOR NEW DATA
COMPRESSING THE NEW DATA, RECONSTRUCTING THE NEW COMPRESSED DATA, AND DETERMINING A RECONSTRUCTION LOSS FOR THE NEW COMPRESSED DATA
DETERMINING A DRIFT DIFFERENCE
UPDATING AN AGGREGATE DRIFT DIFFERENCE
MODEL RETRAINING, MODEL MANAGEMENT INTERFACE, AND OTHER RESPONSIVE ACTION
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. The terms “first” and “second” are used as a naming convention rather than indicating order, unless otherwise indicated. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Drift Management

Machine learning models are used to predict data values that are likely to occur based on other data values. If the machine learning model is trained to make predictions based on data-driven assumptions at a point in time, to, then at some point t>t₀, the data-driven assumptions may no longer be valid or accurate for new scenarios that have never been seen or even for the same data-driven scenarios because the labels have changed over time. Degradation in the model's accuracy can impact software-driven decision-making and, ultimately, the value of the software.

Data drift refers to the degradation of a machine learning model's performance over time due to changes in input data. Drift can lead to erroneous predictions, and such erroneous predictions can be avoided or mitigated by proactively preventing the use of a model that has experienced such drift. The machine learning model may be periodically retrained to prevent long periods of operating with significant data drift, but such retraining has the potential to overlook shorter-period drift events and often unnecessarily and excessively consumes extra resources, leading to extra expense and potentially lower system performance, to retrain models that have not yet drifted.

A model may degrade in performance over time due to data drift, which occurs when the data used to train the model is no longer similar to the data for which the model is making predictions. Data drift may occur for a variety of reasons, including:
changes in circumstances, rules, or laws impacting the set of data, for example, by increasing or decreasing the importance of certain features,
the addition of new species, trends, or patterns not seen before in the set of data,
any other changes that make the new data values being seen individually different from the past data values seen in a manner that could impact model performance, and/or
any other changes that make the new data values being seen interact or co-depend differently from the past data values seen in a manner that could impact model performance.

According to the techniques described herein, drift may be monitored to determine whether significant drift has occurred, and, if so, model retraining or other responsive action may be triggered. Systematic monitoring to detect drift presents a robust and resource-efficient solution to maintain model quality in dynamic environments, making systematic monitoring a well-suited choice for real-world machine learning applications.

Detecting data drift presents a set of significant challenges. Firstly, intricate feature interdependencies can obscure the signs of drift, particularly when changes in one feature cascade into others. Secondly, the available toolbox of metrics for evaluating drift is limited. Also, ground truth labels are often unavailable in real-world scenarios. Lastly, efficiency is balanced with cost when analyzing large volumes of live data streams, and any cost of monitoring drift is multiplied or magnified by the many data consumption events where drift may be separately analyzed. In some systems, these data consumption events are occurring hundreds or even thousands or millions of times a second.

Some methods may monitor drift by measuring model performance over time. For example, the Drift Detection Method (DDM) and Early Drift Detection Method (EDDM) focus on monitoring prediction errors. The Adaptive Random Forest (ARF) algorithm introduces an effective resampling method to handle drift occurrence. However, these approaches rely on ground truth labels, often unavailable in real-world contexts.

Other methods may focus on measuring the distribution of input data features. For example, statistical tests, like the student t-test and Fisher f-test, focus on changes in mean and variance. Such changes may occur in data that has drifted together, with the same inter-feature correlations, and such changes may not show up for data that has drifted to have different inter-feature correlations but similar means and variances. These tests have limited use in detecting more complicated scenarios like this. Other tests such as the Kolmogorov-Smirnov (KS) test and the Population Stability Index (PSI) test may be used to conduct data drift detection. Modified tests like Prediction Accuracy Index (PAI) and the incremental Kolmogorov-Smirnov test have also been proposed to detect drift. These tests still focus on the processing of single features and are not able to efficiently capture feature correlation.

In one embodiment, a drift detector of the data management system uses a dimensionality reduction-based approach for detecting data drift in real-world dynamic environments to prevent model degradation. For example, the drift detector may use a compression and reconstruction process that reduces dimensionality of a base set of data using Principal Component Analysis (PCA) or neural networks to capture both feature distributions and correlations from training data. The drift detector may keep track of the drift detector's ability to fully account for the variance of the base set of data as compared to the drift detector's ability to fully account for the variance of a production set of data using the same algorithm and parameters. This ability to fully account for the variance is equivalent to no data loss, and either factor may be used to determine whether or not the machine learning model should be retrained.

During training, the drift detector may generate and save a drift detection model that minimizes or mitigates data loss during compression and decompression (“reconstruction”) for a base set of data. During inference or production, the drift detector may retrieve the saved drift detection model to compress and reconstruct data samples after the model is deployed. The compression and reconstruction process involves compressing the production set of data into a lower-dimensional space using the model, and using the model to reconstruct the original sample. If the production set of data has similar inter-dependencies and correlations as the base set of data, the compression and reconstruction process will effectively minimize or mitigate data loss as the process did for the base set of data. If the production set of data has different inter-dependencies and correlations as the base set of data, the compression and reconstruction process will be unlikely to effectively minimize or mitigate data loss as the process did for the base set of data.

In one embodiment, the drift detector can identify not only if a particular sample of production data has drift, but also the magnitude of the drift and which features contributed to the drift. The drift detector may output, along with or in addition to predictions from the machine learning model, information about the magnitude or contributing source(s) of the drift (in terms of features), and such information may help a user to understand whether and how the data is drifting to impact the machine learning model.

In comparison with statistical tests, the drift detector may simultaneously analyze multiple features, including inter-feature correlations, and including patterns from all features, all features relevant to the model, or all features marked for inclusion in the drift analysis. The drift detector also allows drift to be determined and maintained on a sample by sample basis for different sets of production data. The drift from the samples may be combined into an aggregate drift metric, analyzed in comparison with each other over time to detect changes in drift, and/or analyzed independently. The ability to feed separate samples into the drift detector allows drift metrics to be maintained efficiently over time without degrading performance as sets of data get larger.

In training and production, an initial data sample is compressed and then reconstructed. The error between the initial data sample and the reconstructed data sample is determined in both training and production so the error during training may be compared to the error during production. In both training and production, the reconstructed data sample will likely not perfectly replicate the initial data sample due to information loss during compression, resulting in what is called the “reconstruction error”. When dealing with samples from the training data, this error is expected to be minimal or mitigated, as the model has learned to retain independent aspects of the data. However, when reconstructing samples with significantly different patterns compared to the training data, the reconstruction error is expected to be substantial. In scenarios where the patterns are significantly different from the training data, more information is lost during compression using the model that was trained to minimize errors for the training data, leading to a reconstructed sample that differs from the initial sample. As the evaluated sample diverges further from the training samples, the reconstruction error grows. This change in reconstruction error serves as an indicator of data drift.

The drift detection techniques described herein allow normalization of data drift during inference time to the training drift. This allows drift to be evaluated for each sample during inference time, whether it is batched or directed to a per-row inference. Drift may also be tracked per feature, which provides visibility into what data columns are causing drift in the sample as compared to the training data. Overall and feature-specific drift metrics described herein may also be aggregated (e.g., summed, or tracked with a moving average) over the course of model deployment to monitor drift over time and/or time-dependent data drift. This can be done using overall drift metric or per-feature drift metric. The drift metrics may also be automatically determined when machine learning models are used and/or when new data is ingested, without requiring additional user input or setup. The drift metrics may be consumed by the data management system to automatically display a warning message about the quality of the trained model with respect to the distribution of data currently being analyzed or recently analyzed. A significant drift difference may also be analyzed as a potential anomaly.

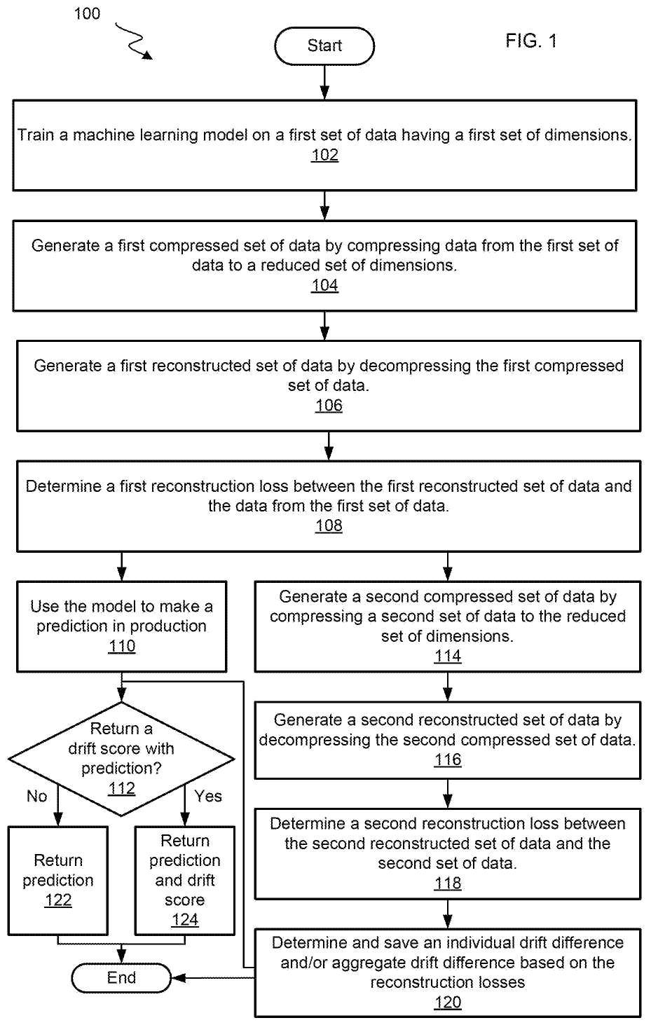

FIG. 1 shows a flow chart that illustrates a process for returning a result of a prediction by a machine learning model and determining and saving a drift difference. Process 100 of FIG. 1 starts with block 102, where a machine learning model is trained on a first or “base” set of data having a first or “base” set of dimensions. Process 100 continues in block 104, where a first compressed set of data is generated by compressing data from the first set of data to a reduced set of dimensions. Then, in block 106, a first reconstructed set of data is generated by decompressing the first compressed set of data. In block 108, a first reconstruction loss is determined between the first reconstructed set of data and the data from the first set of data.

Blocks 102-108 represent a training phase for process 100, which continues in a production phase to block 110 when predictions are made with the trained model and to block 114 when new data is added after training to one or more data repositories that are covered by the model. In block 110, the model is used to make a prediction in production. A determination is made in block 112 on whether to return a drift score with the prediction. If not, the prediction is returned without the drift score in block 122. If a drift score is to be included, the drift score is included with the returned prediction in block 124.

As new data is received, example process 100 continues to block 114 to generate a second compressed set of data by compressing a second set of data to the reduced set of dimensions. Then, in block 116, the process includes generating a second reconstructed set of data by decompressing the second compressed set of data. Process 100 continues in block 118, where a second reconstruction loss is determined between the second reconstructed set of data and the second set of data. In block 120, an individual and/or aggregate drift difference is determined and saved based on the reconstruction losses. Process 100 ends until new data is received or a new request is received to make a prediction using the machine learning model, at which point process 100 resumes at corresponding blocks 110 or 114.

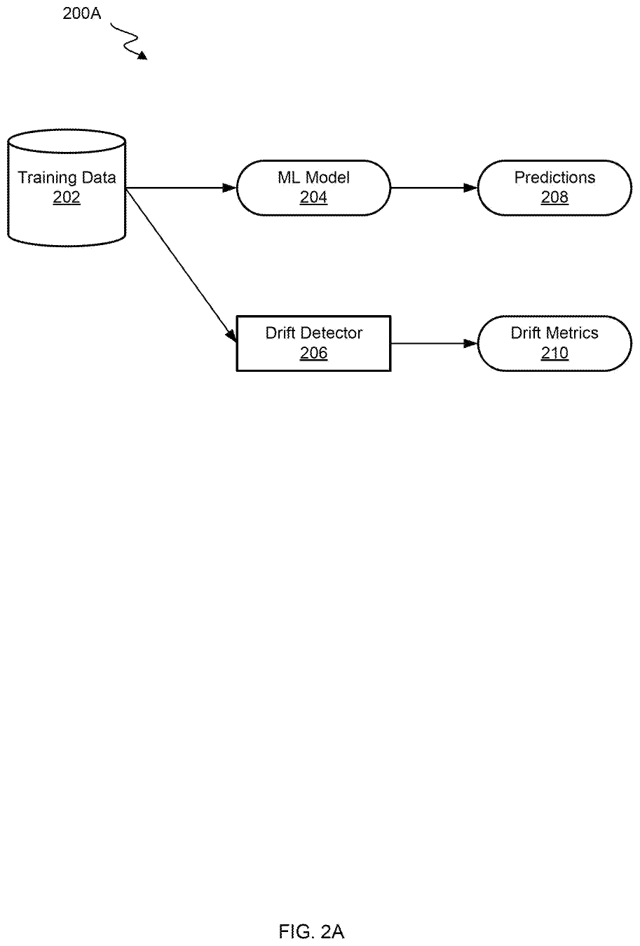

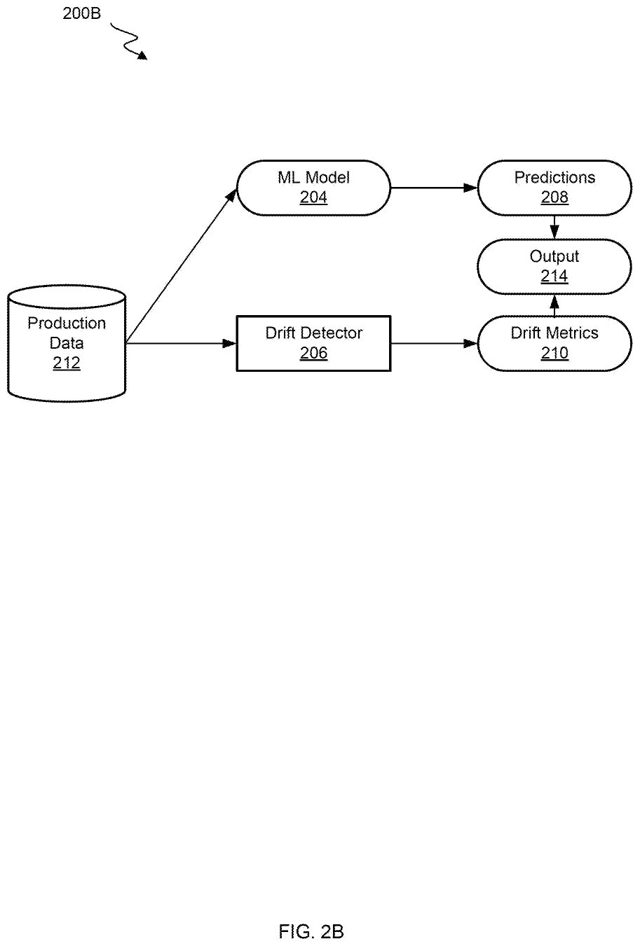

FIG. 2A shows an example data flow 200A during training of a machine learning model and a drift detector. As shown, training data 202 is used to train ML model 204 and drift detector 206. Drift detector 206 is used to determine baseline drift metrics 210, and ML model 204 is used to make predictions 208 that are validated for accuracy.

FIG. 2B shows an example data flow 200B during production using the machine learning model and the drift detector. As shown, production data 212 is input to ML model 204 and drift detector 206. Drift detector 206 is used to determine drift metrics 210 that measure the drift of ML model 204, and ML model 204 is used to make predictions 208. Output 214 may include information from drift metrics 210 and/or predictions 208.

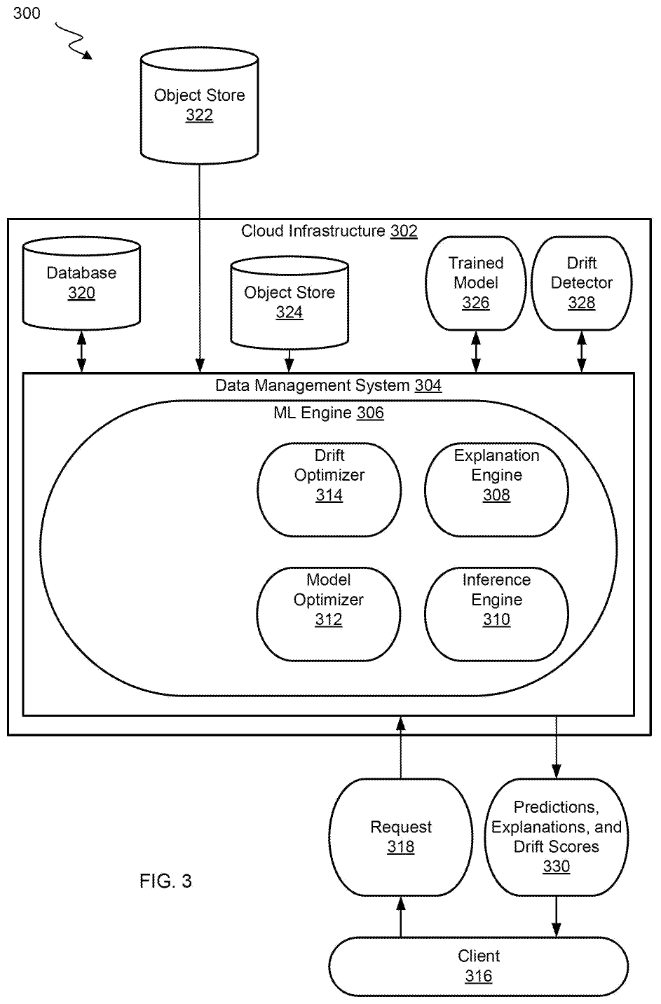

FIG. 3 is a system diagram showing an example system 300 for determining and indicating drift of a machine learning model. As shown, cloud infrastructure 302 includes data management system 304 for processing data and/or requests for data. Data management system 304 includes ML engine 306, which includes drift optimizer 314, explanation engine 308, model optimizer 312, and inference engine 310. Drift optimizer analyzes data from database 320 and/or object stores 322 and/or 324 to determine a baseline drift for use in drift detector 328. Model optimizer 312 analyzes data from database 320 and/or object stores 322 and/or 324 to determine a trained model 326 for predicting values. Inference engine 310 and explanation engine 308 are used for applying the model to incoming requests and explaining results. As shown, predictions, explanations, and drift scores 330 are returned to client 316 in response to request 318.

### Enabling Machine Learning and Training a Model on Data from a Set of Data

In one embodiment, a request is received by a data management system to make a prediction and/or train a model on a set of data. The data management system may be a server, such as a local machine operating data management software, a cluster of computing resources operating together to provide data management services, and/or a server operating in coordination with a cluster to provide data management services, where some processes are offloaded to the cluster and other processes are performed locally by the server. In one embodiment, the cluster is served by a plurality of worker threads on each node that handle distributed tasks in parallel to support generating a model, generating a prediction, and/or determining whether the set of data has drifted too far from the base data set. For example, the worker threads may operate in parallel to select the best algorithm, select the best subset of features, select the best model, ingest requests, make predictions, and update drift metrics for the model. The request to use or train the model may be received from a client of the database management system, such as a device connecting to the database management system with user roles or privileges to perform operations, such as requesting machine learning results, on the database management system.

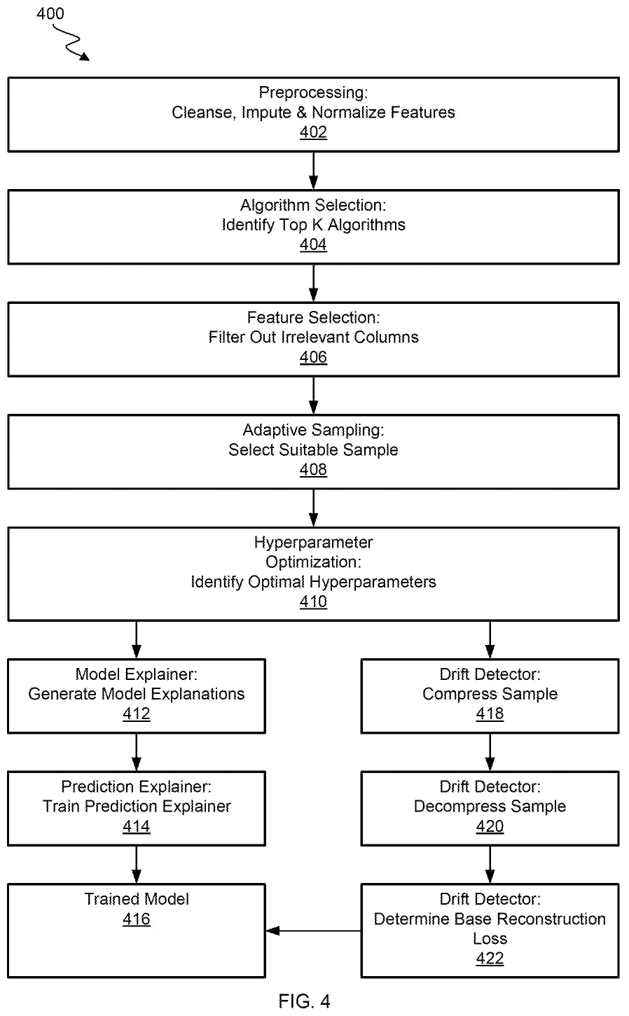

FIG. 4 shows a flow chart illustrating an example process 400 for training a machine learning model and a drift detector. As shown, process 400 starts in block 402, where preprocessing occurs. Preprocessing may include, for example, cleansing data, imputing and normalizing features. Process 400 continues to block 404, where one or more algorithms are selected for the model, for example, after identifying a top K algorithms for similar sets of data or similar predictions. In block 406, the data management system selects which features to include in the model, for example, by filtering out irrelevant columns. In block 408, the data management system adaptively samples data by selecting a suitable sample for inclusion in the training data for the model. In block 410, the data management system performs hyperparameter optimization to identify optimal hyperparameters for inclusion in the model.

Once the features/dimensions of the model are known, model components may be trained in parallel with the drift detector. In the example shown, model explainer 412 is trained to generate model explanations, and prediction explainer 414 is trained to generate prediction explanations. A drift detector may be trained in steps 418, 420, and 422, as shown, where a sample of data is compressed in block 418, decompressed in block 420, and used for determining a base reconstruction loss in block 422. The trained drift detector is incorporated into trained model in block 416.

In a specific example, a user of an application on a client device submits a user request to the application to perform an action dependent on a prediction from the machine learning model. The application may trigger the request to the data management system based on the user request, and use the model to generate a prediction and a drift score and/or confidence score associated with the prediction. The application may consume the drift score and/or the confidence score, as well as the prediction, to suggest an action that takes into account not only the prediction but also the drift score and/or the confidence score. For example, the application may guide the user via a user interface to “accept” or “reject” an option, an offer, or a plan based on the prediction, the drift score, and/or the confidence score. The application may alternatively or additionally display the prediction, the drift score, and/or the confidence score to the user on the user interface.

If the request received by the data management system is an initial request received for the set of data, a model may be trained for the set of data. If the request is after the initial request, a data management system may determine that a model is already trained and available for the set of data. If a model is already available, the prediction may be made using the existing model to return the prediction in response to the request. In a particular embodiment, optionally based on a preference specified for the request, the data management system also returns a confidence score and/or a drift score along with the prediction.

If a model does not already exist for the set of data, the data management system trains a model by finding features (e.g., columns, virtual columns or computations performed on columns, or otherwise dimensions of data) that are historically relevant to a given feature for which predictions are being requested. Some features may be irrelevant to the given feature, such that the values of these features are wholly independent of the given feature. Other features may be relevant to the given feature but redundant with other features that are more relevant or equally relevant to the given feature. Additional features may be uniquely relevant to the given features but with such a low predictive probability over the whole set of data that the additional features would not add much predictive value to a model that makes predictions for a wide range of data value circumstances for the set of data. In one embodiment, those features that are irrelevant, redundant, or of limited relevance are filtered out in a preprocessing step before the machine learning model is trained. In one example, a number of included features may be reduced from 1000 to 100 or from 100 to 10. The magnitude of feature reduction obtained through feature selection may vary from set of data to set of data.

The data management system may detect features to exclude from the machine learning model in a variety of ways. In one embodiment, different versions of the model may be trained to predict values based on different subsets of features of historical data, and an accuracy score may be determined for each of the different versions of the model based on actual values that are also available from the historical data. The features present in the version(s) having the highest accuracy score may be retained as relevant features. In another embodiment, features are ranked based on feature importance, and the most important features are retained without having to train enough versions of the model to cover all of the different features. In a particular example, feature importance may be determined based on a decision tree classifier such as an extremely randomized trees classifier (extra trees), and subsets of the most important features may be created with different versions of the model trained on the subset of the top N most important features, increasing N until a model is found that performs predictions well enough to satisfy predictiveness criteria. N may be increased linearly, exponentially, or in some other progression, starting at an initial value, until a set of relevant features is determined.

In one embodiment, the data management system selects a machine learning algorithm of a plurality of available machine learning algorithms based on the set of data before the machine learning model is trained. The algorithm may be selected based on characteristics, distributions, data types, and volume of data in the data set. Some algorithms may historically perform better for larger sets of data, sets of data with wider distributions, and/or certain data types, and other algorithms may perform better for smaller sets of data, sets of data with narrower distributions, and/or other data types.

Remaining features of the set of data that survive feature selection may be used for training the model. In one embodiment, the set of data is split up into a training sample for use in training the model and a test sample for use in validating the trained model. For example, the training sample is 80% of the set of data, and the test sample is 20% of the set of data. In other embodiments, the percentages vary and may not even add up to 100% of the set of data being used. In one embodiment, rows of the set of data may be randomly or pseudo-randomly reduced to ensure a variety of data remains in the set of data, for example, having a similar value distribution, without including the entire set of data in the training and/or testing phases. In another embodiment, 100% of the set of data is used for training, and a smaller sample of the set of data is used as the test sample. Overlapping the training sample with the test sample risks overfitting in some sets of data, for example, where results are deterministic based on the input features in the sense that the same input feature values always map to the same result but where not all possible input feature values have been seen in the sample. In these examples, the model may be learning the precise deterministic mappings rather than higher-level patterns that can be applied more generally. An overfit model may, in these cases, be less efficient and reliable at handling new data that does not exist in the sample. In other sets of data, there is less risk to overtraining either because there is no unseen data or because the results are unpredictable enough that higher-level patterns are learned.

The model may be trained on one or more sets of data or portions or samples thereof, such as data stored in a training data repository. The model may be trained to predict one or more values along an initial set of dimensions that aligns with the one or more sets of data or portions thereof, optionally after feature reduction has occurred during preprocessing. The one or more sets of data include combinations of value occurrences in the set dimensions. As discussed in more detail in later sections, a drift detector may compress the same or different sets of data or portions thereof than were used for training the model, reducing the data to a reduced number of dimensions, and reconstruct the compressed data to the initial set of dimensions determine how much data was lost. The same compression and decompression process is used for production data to reduce the production data to the reduced number of dimensions and reconstruct back to the initial set of dimensions. As a result, the drift detector may determine whether more data loss is occurring with respect to the production data than was occurring during the training phase.

The trained model may be stored in a model object catalog specific to the tenant, group of users, or user for which the prediction is requested. The model object catalog may store trained models for making a plurality of different predictions on a plurality of same or different dimensions for a plurality of same or different sets of data. The model object catalog stores the trained models along with metadata about the trained models, for example, in a table. The model object catalog may also store the drift detector and/or drift metadata that tracks drift for each or a subset of the models.

The test sample is used to validate the trained model by inputting dimensions other than the dimension to be predicted from the test sample into the trained model. The trained model then predicts a value for the dimension to be predicted, the data management system determines whether the predicted values align with the actual values in the test sample. For example, an accuracy of the model may be evaluated based on the test sample, which was not used to train the model.

In one embodiment, the data management system integrates database server processing and machine learning (ML) capabilities to enable users to train ML models and generate inferences and explanations across data stored in MySQL® databases and data lakes. One example such data management system is HeatWave® AutoML data management system from Oracle® Corporation. Machine learning processes may be performed inside the data management system integrated with the database server, meaning there is no need to extract data out of the database to perform ML. Data and models may be retained in the database to improve efficiency and data security. The data management system may operate on the data without clients or any other services seeing the data or models via an external-facing database service. In one embodiment, the data management system fully automates the creation of tuned models, generating inferences and explanations, eliminating the need for the user to be an expert ML developer. The data management system supports multiple model types, including, but not limited to, Classification, Regression, Time Series Forecasting, Anomaly Detection, Recommender System, etc.

The data management system may also provide a MySQL® interface or any other data query or machine learning query interface for invoking machine learning capabilities. In one embodiment, the data management system uses Python ML packages that can be swapped out in place to enable continual and swift upgrades to machine learning capabilities.

The data management system may scale up with larger data sets and higher workloads by using worker threads to handle incoming requests in parallel, performing predictions for different requests in parallel, and detecting and updating drift for different incoming sets of data in parallel. The data management system may distribute individual model fits and multiple parallel fits to available compute nodes on a given cluster. The data management system may also be optimized for both intra- and inter-model parallelism to achieve optimal performance on data management system cluster nodes. In one example implementation, the data management system can scale to dozens of data management system nodes (including hundreds of cores), significantly reducing the ML training runtime as the cluster scales up. Furthermore, as training data size grows, the data management system may offer options via a user interface to scale up the cluster size to minimize the increase in training time.

In one embodiment, machine learning models created by the data management system can be explained, in terms of what features contributed most to generating predictions. Enterprises have a growing need to explain the predictions of machine learning models to build trust and transparency, demonstrate fairness, and comply with regulatory requirements. The data management system may provide an explanation of features contributing to a prediction for algorithms affecting users, provide a human-interpretable explanation of the prediction and the features feeding into the decision, ensure that predictions are unbiased and do not implicitly or explicitly discriminate against underrepresented groups or consider certain excluded features, ensure that small changes in the input do not lead to large changes in the prediction, and ensure that users can check that only causal relationships are picked up.

In one embodiment, the data management system operates on data stored in the database and natively applies ML techniques and drift detection without moving the data out of the database. Extracting data and moving the data in external systems to leverage the power of ML adds complexity, duplicates data, and compromises the security of both the data and the model. In a particular embodiment, the data management system may perform machine learning model training, validation, and drift detection in memory while persisting models, metadata, and results in the database.

In one embodiment, the data management system provides an interface for database users, including MySQL® users, to use the data management system to create machine-learning models for their data in the database. The data management system may accomplish this without users needing to extract data out of the database, use an external machine learning framework to train the model, and without having to reload the model to the database. In other words, the data management system supports machine learning in MySQL® without requiring the user to perform any ETL (Extract, Transform, Load) operations on the database table for which ML is performed.

In one embodiment, the data management system maintains data-driven rules, models, and/or customized settings to automatically determine:
which algorithms or models to select from which candidate algorithms or models,
which hyperparameters to tune for each algorithm, in an algorithm-specific manner with different hyperparameters being tuned for different algorithms,
which features to select as relevant to the model and prediction, what data preprocessing to perform on which different columns of the raw data feeding into the model,
whether the model performs well on unseen data, and/or
how to detect drift and when to retrain models.
   The model parameters and settings may be automatically determined, and the model automatically generated and trained, without user input beyond requesting a machine learning prediction for a set of data, or otherwise requesting that a machine learning model be generated.

In one embodiment, analytics queries and ML queries share a common query queue, and analytic queries may be executed without accessing ML models that are used to process ML queries. The queries may be marked with ML commands or not, and the markings may determine whether the query uses ML resources or standard resources to process the queries.

In one embodiment, during model creation, the data management system provides an option for the user to specify information about the expected results and the type of problem. The data management system may select a model for the user, and/or the data management system may provide the user with an option to select the appropriate model type for the problem. The data management system may receive, via user input, information about identified valid data attributes and the relationship between these attributes. The data management system uses this data to automatically create the model.

In a specific example, the data management system may receive one of the example queries below to trigger training of a ML model and a corresponding drift detector.

### Example Query 1

MySQL®>CALL sys.ML_TRAIN(‘mlcorpus.census_train’, ‘revenue’, JSON_OBJECT(‘task’, ‘classification’), @model);

### Example Query 2

MySQL®>CALL sys.ML_TRAIN(‘mlcorpus.boston_train’, ‘target’, JSON_OBJECT(‘task’, ‘regression’), @boston_model);
   The example queries use the ML_TRAIN command to request a model to be trained, specify the set of data to train, the column to predict, and the algorithm and model to use for the prediction.

In one embodiment, the data management system stores model information and metadata in a model catalog. The model catalog provides a standardized way to store ML models. In a specific example, the model catalog is a table (MODEL_CATALOG) within the user schema (ML_SCHEMA_<current username>) created by ML_TRAIN if it does not already exist. The model catalog may store any models trained during ML_TRAIN as a row in the MODEL_CATALOG table. The model catalog makes ML models first-class citizens of the database, enabling them to be backed up, restored, encrypted, and follow other DB procedures and protocols that regular DB tables provide. The catalog also helps with the sharing of models between multiple users as owners can control access and rights to their tables.

In one embodiment, the models stored in the model catalog may be loaded in memory before they are used with the ML_MODEL_LOAD routine. A model remains loaded until it is unloaded using the ML_MODEL_UNLOAD routine or until the database management system driver is restarted. Example queries to load (Example Query 3) and unload (Example Query 4) a model are as follows:

### Example Query 3

MySQL®>CALL sys.ML_MODEL_LOAD(@model, NULL);
Result: Query OK, 0 rows affected (1.12 sec)

### Example Query 4

MySQL®>CALL sys.ML_MODEL_UNLOAD(@model);
Result: Query OK, 0 rows affected (1.12 sec)

In one embodiment, the data management system supports building ML models on data stored in an object store. The data management system enables querying data in the object store, stored in a variety of file formats, such as, for example, CSV, Parquet, Avro and exports from databases (e.g., Aurora®, Redshift®, MySQL®, Oracle®). The data management system supports machine learning on data sourced from both the object store or the database and allows ML models to cover both MySQL® and non-MySQL workloads, for example, using a single API. This ability to use content from varied sources simplifies machine learning tasks by combining analysis for a data warehouse or other object store and the database.

In one embodiment, a user can connect to the data management system using an interactive notebook environment and run transactional, analytics and machine learning queries. In addition, in the notebook environment, the data management system supports can features available for numeric computations, data processing, data visualization and more using a language of choice.

In one embodiment, machine learning is activated or enabled on a specified set of data based on a received query. Data from the set of data may be selected for inclusion in machine learning based on which features (e.g., features or columns) of the data potentially impact a column for which a prediction is requested.

The model may be generated and trained to produce results using a first set of data, the training set. A base set of data may be partitioned into two segments, the training set of data and the testing set of data. The training set may be used to train the model as well as a drift detector. In another embodiment, another subset of data from the base set of data, which may or may not overlap with the training set of data or the testing set of data, is used to train the drift detector. The testing set of data is used to determine an accuracy of the model predictions by inputting partial value combinations from the testing set of data even though full value combinations are already known.

### Compressing and Decompressing Drift Training Data

In one embodiment, the machine learning model results from a preprocessing step that includes selecting features that are most relevant to the model's accuracy in making predictions. Those features that are not included in the current model due to feature reduction may be excluded from the compression, decompression, reconstruction loss determination, and drift determinations, with a focus on those subset of features that were determined to be relevant to the current model. In other words, if, through feature selection, the data management system chose 50 out of 1000 columns to be included in the model, the data management system may perform compression, decompression, determine a reconstruction distance and, later, a drift based on the 50 columns, optionally ignoring any drift that may be occurring in the 950 unselected columns. In another embodiment, drift is determined for the 50 included columns synchronously with ingestion of new data, and drift is determined for the 950 unselected columns synchronously or asynchronously (e.g., in a periodic process) in a separate process that re-evaluates whether previously unselected columns have become more relevant based on newly or recently labeled data. If the previously unselected columns have become more relevant, as determined in the separate process, the data management system may trigger a retraining of the model.

After feature reduction is performed on a base data set, the remaining features have already been determined by the data management system to be relevant for inclusion in the model for predicting values such that the remaining features are not fully codependent or perfectly correlated with each other. In other words, attempting to compress a base set of data may result in some data loss that cannot be fully recovered on decompression. However, a compression and decompression model can be trained to minimize the amount of data lost if this process is performed on the base set of data, leveraging the correlations and combinations that frequently occur in the base set of data to the extent that any exist. Data drift can be detected when this compression and decompression process is performed on new data and results in higher data loss than what would have been expected for the base set of data. The higher data loss would be due to differences in data-to-data correlations and dependencies than what occurred for the base set of data. This process of detecting data drift begins with compressing a base set of data during a training phase to determine how much data loss is expected for the base set of data.

In one embodiment, a request to train a model for a set of data and/or a request to predict a value using a model for a set of data automatically triggers a process of preparing to detect drift and subsequently detecting drift in the set of data. In another embodiment, the process of preparing to detect drift and subsequently detecting drift is triggered manually or periodically for the set of data, or via a separate monitoring service. The process of preparing to detect drift includes compressing data from a base set of data, which may be a sampled subset or a full set of the overall modeled data and may be a same, different, or overlapping subset than that which was used for training or testing the model. The compressed set of data is compressed by reducing the model's number of dimensions into a fewer number of dimensions. The process of preparing to detect drift further includes reconstructing the compressed set of data back to the model's number of dimensions, and determining a reconstruction loss between the reconstructed set of data and the base set of data. The reconstruction loss may be further used to determine drift and aggregated drift.

The process of preparing to detect drift may be performed by creating a drift detector to be stored in the model catalog along with the model. The drift detector may store a reconstruction loss of a base set of data for use in determining drift, and an aggregate drift from subsequent sets of data detected so far. The aggregate drift may be expressed in terms of total drift across all dimensions and/or drift across individual dimensions of the set of data.

In one embodiment, the data management system receives a request to train a machine learning model on a base set of data. The model is trained, and a drift detection training process is also triggered. As part of the drift detection training process, at least some selected data from the base set of data is compressed from a base set of dimensions to a reduced set of dimensions. The reduced set of dimensions may have fewer dimensions than the base set of dimensions, such as a reduction that occurs when principal component analysis (PCA) is performed on the selected data or when the selected data is fed into a neural network for reducing dimensionality of a set of data by detecting the most prominent features of the set of data.

In one example, PCA may detect one or more hyperplanes along which the selected data varies most. Each hyperplane may cover a selected combination of value occurrences of the selected data. The hyperplanes may be selected to be orthogonal to each other to promote efficient coverage of variant data. The selected data may be described in terms of the selected data's distance from each hyperplane among the fewer dimensions of hyperplanes. In one example, PCA may be performed in linear time with minimal overhead and can be performed during training and in parallel at inference time.

In another embodiment, a neural network may be used to reduce the dimensionality of the selected data from the base set of data. The neural network may have several layers, each designed to detect different types of prominent features in the selected data, and the layers may use one or more feature embedding vectors that describe detected relationships and dependencies among the features, extreme (max or min) values, approximate value distributions, other aggregate values that describe data features, or other automatically detected observations about the selected data. The layers of the neural network may consume feature embedding vectors to produce an output set of dimensions that are predicted to provide coverage of the selected data.

Whether PCA or a neural network is used, the different dimensions may be selected in the reduced dimensionality space to account for a maximum remaining variance in the selected data, to reduce the amount of data unaccounted for or data loss when reducing the selected data to fewer dimensions, and/or to efficiently represent the selected data with low-cost transformations.

### Reconstructing the Compressed Data

The compressed set of data is reconstructed in the base set of dimensions to generate a reconstructed set of data by decompressing the compressed set of data. The compressed set of data may be decompressed using the same operation used to compress the set of data. The base set of data includes X dimensions and the compressed set of data includes Y=X−k dimensions, where k is the reduction factor. To the extent that some of the data in the X dimensions was aligned with or otherwise correlated with data retained in the Y dimensions, the correlated data may be retained during transformation from X to Y and back to X dimensions. Other data that was not aligned or otherwise correlated with any dimension of the retained data may be lost during the transformation.

For example, if the base set of data was reduced to Y dimensions by PCA, the Y dimensions may be represented as Y hyperplanes along which the X-dimensional data varies most. Each of the Y hyperplanes may cover a selected combination of value occurrences of the X-dimensional data. The Y hyperplanes may be selected to be orthogonal to each other to promote efficient coverage of variant data. The X-dimensional data may be described in terms of the X-dimensional data's distance from each hyperplane among the Y dimensions of hyperplanes. If the X-dimensional data has a distance of 0 from multiple hyperplanes in the Y-dimensional space or can otherwise be perfectly triangulated in the Y-dimensional space, the X-dimensional data may be retained without data loss in Y dimensions. During decompression in these scenarios, the data management system is able to determine exactly where the X-dimensional point should be.

In other scenarios where the point in Y-dimensional space cannot be triangulated to an X-dimensional data point, the data management system estimates the reconstructed point based on the most dense portion of the data distribution in X-dimensional space that matches the Y-dimensional coordinates, and/or based on an average or other aggregate value in X-dimensional space that matches the Y-dimensional coordinates. The data management system selects this estimated point as the reconstructed point, which may be different than the actual data point that was compressed.

In another embodiment, a neural network may have been used to reduce the dimensionality of the X-dimensional data to Y dimensions, and the neural network may be similarly used to increase the dimensionality of the Y-dimensional back to X dimensions. The outputs of each layer of the neural network may be mapped to the most likely inputs that produced the outputs, traversing the neural network in reverse based on probability. In one scenario, because the X-dimensional data perfectly matched one or more of detected relationships and dependencies among the features, extreme (max or min) values, approximate value distributions, other aggregate values that describe data features, or other automatically detected observations about the selected data, the reverse traversal of the neural network using the Y-dimensional data is able to produce an X-dimensional data point that matches the original X-dimensional data point with no data loss. In another scenario, the reverse traversal of the neural network is not able to determine with certainty the precise X-dimensional data point and instead determines a most dense portion of the data distribution in X-dimensional space that matches the Y-dimensional coordinates or layer outputs that resulted from compressing the X-dimensional space to Y-dimensional space using the neural network layers, and/or based on an average or other aggregate value in X-dimensional space that matches the Y-dimensional coordinates or layer outputs. The data management system selects this estimated point as the reconstructed point, which may be different than the actual data point that was compressed.

### Determining a Reconstruction Loss

In one embodiment, the data management system determines a first reconstruction loss between the reconstructed set of data and the selected data used in the compression and decompression process. The reconstruction loss accounts for differences between the reconstructed set of data and the selected data along the set of X dimensions corresponding to the selected data from the base set of data.

The reconstruction loss may be expressed in scalar and/or vector form. In one embodiment, the reconstruction loss includes a reconstruction difference (RD) as a vector illustrating the discrepancy between the original sample and its reconstructed version, quantifying the gap introduced during reconstruction.

$$RD = \vert reconstructed\_sample - original\_sample \vert$$

In the same or another embodiment, the reconstruction loss includes a Reconstruction Error (RE) as a scalar value that provides an aggregate assessment of RD. In one embodiment, RE is determined as the Mean Squared Error (MSE) of RD, averaged across all features F.

$$R E = \frac{1}{F} {\sum }_{i = 1}^{F} {( {reconstructed}_{i} - {original}_{i} )}^{2}$$

The RE provides a metric that can be summed or aggregated across multiple samples to accumulate an aggregate reconstruction error or difference, which may be tracked in a feature-specific manner for individual features being reconstructed or inclusive of all features being reconstructed.

During model training, a PCA-based drift detector may be trained to compress and decompress data with mitigated loss, and the quality of the detector at mitigating reconstruction loss is indicated by the mean and variance of the RDs and REs of the training samples, is stored.

In one embodiment, as part of determining the reconstruction loss for the training data, the drift detector determines a training drift metric mean, variance, and/or standard_deviation. These numerical values represented by the equations below measure the drift detector's performance in reconstructing the training data across N samples. They are real numbers that vary between 0 and infinity and may be determined as the average or mean the variance and/or the standard deviation of the drift metric.

$$training\_drift \_metric \_mean = \frac{1}{N} {\sum }_{i = 1}^{N} training\_sample {\_RE}_{i} training\_drift \_metric \_var = \frac{1}{N} {\sum }_{i = 1}^{N} {( training\_sample {\_RE}_{i} - training\_drift \_metric \_mean )}^{2}$$

$$training\_drift \_metric \_std = \sqrt[2]{training\_drift \_metric \_var}$$

$$( N = number of training samples )$$

The drift detector may also determine training difference mean, variance, and/or standard_deviation. These metrics function similarly to training drift metric mean, variance, and/or standard_deviation above. However, instead of assessing the overall error, these metrics focus on individual features, resulting in vector outputs as indicated in the equations below.

$$training\_diff \_mean = \frac{1}{N} {\sum }_{i = 1}^{N} training\_sample {\_RD}_{i} training\_diff \_var = \frac{1}{N} {\sum }_{i = 1}^{N} {( training\_sample {\_RD}_{i} - training\_diff \_mean )}^{2}$$

$$training\_diff \_std = \sqrt[2]{training\_diff \_var}$$

$$( N = number of training samples )$$

The operations in the above equations are conducted in a vector-based manner, where each element is processed individually.

The reconstruction loss for the base model and later for production data may be determined in a variety of manners involving a comparison of the X-dimensional data pre-compression with a comparison of the X-dimensional data post-decompression to determine how much data was lost during the compression and decompression process.

In one embodiment, the reconstruction loss is determined by applying a mask or weight to feature-specific losses for the set of features, based on weights used in or importance determined for the machine learning model. For example, features that are very different between the input set of data (e.g., the base set of data or the incoming set of data) and the reconstructed version of that set of data may be scaled down if they were included but not highly weighted or of high importance in the machine learning model, relative to other features. As another example, features that are similar between the input set of data and the reconstructed set of data may be scaled up if they were highly weighted or of high importance in the machine learning model, relative to other features. Similarly, features that are already different may be scaled up to be even more different if they were highly weighted or of high importance in the machine learning model, relative to other features. In yet another example, features that are similar between the input set of data and the reconstructed set of data may be scaled down to be even more similar if they were not highly weighted or of high importance in the machine learning model, relative to other features.

In one embodiment, the reconstruction loss determination may exclude certain features that were lowly weighted or of low importance in the machine learning model, relative to other features. In this embodiment, even though certain features may widely vary and even drift after the machine learning model is trained, such features may have been marked as high variance and low importance features that should not be included in the reconstruction loss determination and should not be taken into account in the drift difference or aggregate drift difference determinations.

In one embodiment, if a reconstruction loss for a base set of data is too high, a user may be notified that the set of data has high variance which may result in frequent or too frequent retraining. Additionally or alternatively, the data management system may determine that the set of data would have lower variance and a more appropriate retraining cadence if certain features were excluded from drift analysis, for example, because the features have too high a variance and/or too low an impact on the machine learning model's predictions due to low weight from low feature importance. The drift management system may automatically exclude such features from drift analysis or may prompt the user on whether such features should be excluded for drift analysis. Such notifications about highly variant features may cause the user to make adjustments in the model and/or the set of data to better prepare the data for modeling and subsequent drift detection.

### Using the Model to Make Predictions for New Data

In one embodiment, the machine learning model is used to make predictions on data sets that include particular combinations of value occurrences. The machine learning model may be used before additional data has been received to cause drift for the model, concurrently with other data being received that is causing drift for the model, and/or after other data has been received that is causing drift. The drift determination may be done in parallel with machine learning requests, and drift results may be provided with a prediction generated for a request whether the drift results were computed before the request was received or after the request was received but before the prediction is provided.

The predictions may be prompted by missing data values indicated in a request containing other non-missing data values. For example, a set of production data may include values for some columns but not include a value for at least one column. The data management system may be prompted to predict the value for the at least one column using machine learning. To generate a result, the data management system may provide the input known column value(s) to a machine learning model for predicting the unknown column value(s), and the machine learning model may provide an output prediction that can be returned to the user as part of a result in response to the request.

In one embodiment, along with results of applying the machine learning model to the new data to make a prediction, the data management system provides a confidence score for the prediction. The confidence score may be based on a variety of factors including, for example, an amount of drift detected in the set of data after a training phase so far, an amount of drift attributable to the new data for which the prediction is made, an amount of drift in one or more individual features of the set of data, such as features for which prediction(s) are requested, after the training phase so far, and/or an amount of drift in one or more individual features of the set of data, such as features for which prediction(s) are requested, attributable to the new data for which the prediction is made. Methods for determining such drift metrics are described in further detail in the next section.

The data management system may receive a variety of queries or other requests for machine learning predictions on data stored in a database. In one embodiment, the data management system supports a query to predict outcomes of specific rows using a command, such as ML_PREDICT_ROW. The ML_PREDICT_ROW command is a stored function that runs in-line inference on a single row of data using a previously trained model. The command receives an input row of data in the JSON format, for which the prediction is performed using the trained model object. An example query to predict a row is as follows:

### Example Query 5

MySQL®>SELECT sys.ML_PREDICT_ROW(‘{“index”: 1, “age”: 38, “workclass”: “Private”, “fnlwgt”: 89814, “education”: “HS-grad”, “education-num”: 9, “marital-status”: “Married-civ-spouse”, “occupation”: “Farming-fishing”, “relationship”: “Husband”, “race”: “White”, “sex”: “Male”, “capital-gain”: 0, “capital-loss”: 0, “hours-per-week”: 50, “native-country”: “United-States” }‘, @model);
Result: {“age”: 38, “sex”: “Male”, “race”: “White”, “index”: 1, “fnlwgt”: 89814, “education”: “HS-grad”, “workclass”: “Private”, “Prediction”: “<=50K”, “occupation”: “Farming-fishing”, “capital-gain”: 0, “capital-loss”: 0, “relationship”: “Husband”, “education-num”: 9, “hours-per-week”: 50, “marital-status”: “Married-civ-spouse”, “native-country”: “United-States” }1 row in set (2.36 sec)

As shown, the model is used to predict a salary for the input row that included a variety of column values but without the value to be predicted. The result includes the predicted salary based on the provided values.

In one embodiment, the data management system provides an option to create predictions for an entire table using the ML_PREDICT_TABLE command. The ML_PREDICT_TABLE command creates and populates a new table with features and predictions for each row of the input table. Predictions across rows may be done in parallel, for example, by different worker threads. Example Query 6 below shows use of the ML_PREDICT_TABLE command to create predictions across a table, and Example Query 7 below shows predictions being selected from the table.

### Example Query 6

MySQL®>CALL sys.ML_PREDICT_TABLE(‘mlcorpus.census_test_temp’, @model, ‘mlcorpus.census_predictions’);
Result: Query OK, 0 rows affected (4.54 sec)

### Example Query 7

MySQL®>SELECT ‘index’, ‘education-num’ AS education_level, ‘hoursper-week’ AS hours_per_week, Prediction FROM census_predictions;
Result:

| index | education_level | hours_per_week | Prediction |
+-------+-----------------+----------------+------------+
| 0 | 7 | 40 | <=50K |
| 1 | 9 | 50 | <=50K |
| 2 | 12 | 40 | <=50K |
| 3 | 10 | 40 | >50K |
| 4 | 10 | 30 | <=50K |
+-------+-----------------+----------------+------------+
5 rows in set (0.00 sec)

In one embodiment, the data management system provides an option to Explain predictions on a row. Predictions can be explained for a specific row using the ML_EXPLAIN_ROW command. The ML_EXPLAIN_ROW command is a stored function that causes the data management system to create in-line explanations from a single row of input data. Explanations help the user perform knowledge discovery by explaining which features matter most to the model (captured during ML_TRAIN), and which features contribute the most to individual predictions (via ML_EXPLAIN).

### Example Query 8

MySQL®>SELECT sys.ML_EXPLAIN_ROW(‘{“index”: 1, “age”: 38, “workclass”: “Private”, “fnlwgt”: 89814, “education”: “HS-grad”, “education-num”: 9, “marital-status”: “Married-civ-spouse”, “occupation”: “Farming-fishing”, “relationship”: “Husband”, “race”: “White”, “sex”: “Male”, “capital-gain”: 0, “capital-loss”: 0, “hours-per-week”: 50, “native-country”: “United-States” }‘, @model);
Result:
{“age”: 38, “sex”: “Male”, “race”: “White”, “index”: 1, “fnlwgt”: 89814, “education”: “HS-grad”, “workclass”: “Private”, “Prediction”: “<=50K”, “occupation”: “Farming-fishing”, “capital-gain”: 0, “capital-loss”: 0, “relationship”: “Husband”, “education-num”: 9, “capital-loss_attribution”: 0.0, “relationship_attribution”: 0.0928, “education-num_attribution”: 0.1305, “hours-per-week_attribution”: 0.1806, “marital-status_attribution”: 0.0676, “native-country_attribution”: 0.0001}
1 row in set (4.41 sec)

As shown, in the example result of Example Query 8, several “_attribution” factors are provided that give a weight that each feature played in determining the prediction, with higher-weighted features having a bigger impact on the result than lower-weighted features.

In one embodiment, the data management system supports explain predictions on a table. The sys.ML_EXPLAIN_TABLE creates and populates a new table with features, predictions, and explanations for each row of the input table. Explanations across rows may be done in parallel, for example, via worker threads. The loaded model's training columns correspond with the ML_EXPLAIN_TABLE input columns. Example Query 9 requests for explain predictions on a table, and Example Query 10 selects explain predictions from the table.

### Example Query 9

MySQL®>CALL sys.ML_EXPLAIN_TABLE(‘mlcorpus_v4.census_test_naive’, @model, ‘mlcorpus_v4.census_explanations’);
Result: Query OK, 0 rows affected (12.95 sec)

### Example Query 10

MySQL®>SELECT ‘index’, ‘education-num’ AS education_level, ‘hoursper-week’ AS hours_per_week, Prediction, ‘education-num_attribution’ AS education_level_attr, ‘hours-per-week_attribution’ AS hours_per_week_attr FROM census_explanations;
Result:

| index | education_level | hours_per_week | Prediction | education_level_attr |
hours_per_week_attr |
+-------+-----------------+----------------+------------+----------------------+---------------------+
| 0 | 7 | 40 | <=50K | −0.001 | −0.002 |
| 1 | 9 | 50 | <=50K | −0.1307 | −0.1807 |
| 2 | 12 | 40 | <=50K | −0.2435 | −0.2101 |
| 3 | 10 | 40 | >50K | 0.007 | 0.0053 |
| 4 | 10 | 30 | <=50K | 0.0007 | −0.0002 |
5 rows in set (0.00 sec)

As shown in the result of Example Query 10, education_level_attr and hours_per_week_attr are provided for each row of the prediction to show how much education_level and hours_per_week attributed to the results.

In one embodiment, the data management system uses the ML_SCORE command to compute the model quality by generating predictions on given test data and comparing the predictions to the ground truth labels. The ML_SCORE API uses a string argument that specifies the scoring metric to be used. The data management system may support multiple scoring metrics for classification and regression. Example Query 11 requests to score a model for the model's balanced accuracy in making predictions. Example Query 12 selects the generated score.

### Example Query 11

MySQL®>CALL sys.ML_SCORE(‘mlcorpus_v4.census_test’, ‘revenue’, @model, ‘balanced_accuracy’, @score);
Result: Query OK, 0 rows affected (5.34 sec)

### Example Query 12

MySQL®>SELECT @score;
0.7961280941963196
1 row in set (0.00 sec)

In one embodiment, the data management system provides time series forecasting to predict future values of key metrics based on past events. Time series forecasting involves using time ordered events from the past as well as other variables to predict future values. Multivariate time series forecasting can predict multiple time ordered variables, where each variable is dependent on its past value as well as the past values of other dependent variables.

For example, demand for electrical energy depends on the demand for other sources of energy such as wind and solar. The future monthly consumption of electricity, wind, and solar energy of a region is contingent on the prior year's consumption in each of these categories, and there is an interdependency amongst them. Demand for each of these energy sources also depends on the severity of winter which is independent of demand for various categories of energy sources.

In another example, the seasonal demand for corn is dependent on its past demand and the seasonal demand for other grains. Thus, the demand for various grains is interdependent. The demand for corn also depends on independent variables such as the amount of rainfall. These kind of forecasting problems can be addressed using multivariate time series forecasting.

While analyzing time series, the data management system may automatically detect temporal dependency and internal structure comprising of elements such as seasonality, trend, and residual. There are several time series forecasting algorithms, each having different strengths and weaknesses, and the data management system may select the algorithm based on the problem involved, as specified.

The data management system may include an automated forecasting pipeline that can automatically preprocess data, select the algorithm predicted to provide the best predictions, and tune the model's hyperparameters for a given time-series set of data. The time-series stage prunes the search space and estimates basic time-series characteristics (seasonality, trend etc.) and these estimates are used later by the algorithm selection and hyperparameter tuning stages. The algorithm selection stage estimates the best algorithm for a given time-series set of data from the set of supported algorithms. The hyperparameter tuning stage tunes the hyperparameters for the algorithm in a range suggested by the preprocessor. The preprocessing and tuning steps may reduce the number of trials and improve generalization of tuned models.

In one embodiment, the data management system detects anomalies in unlabeled data using Generalized kth Nearest Neighbors (GkNN), which is based on a single ensemble algorithm that does not require tuning of hyperparameters. The data management system may identify common types of anomalies such as local, global, and clustered which typically require separate algorithms to detect. In other examples, the data management system may also use k-th Nearest Neighbor or Local Outlier Factor.

In one embodiment, the data management system provides a recommender system to recommend new products to users based on their prior history and preferences. The data management system finds patterns in consumer behavior to predict users' preferences, even before they have interacted with the product. The recommender system may use models based on collaborative filtering methods. These models are trained uniquely on past user-item interactions.

The data management system may support recommendations and/or predictions based on both explicit and implicit feedback. Explicit feedback includes data ratings provided directly by users. Example models used by the recommender system to handle explicit feedback include, but are not limited to, NormalPredictor, Baseline, Slopeone, CoClustering, SVD, SVDpp, and NMF. Implicit feedback includes information produced from user behavior like clicks and purchases without direct ratings. The data management system may support the following types of example recommendations:
Items that the user will like
Users who will like an item
User ratings of an item
Identify similar users
Identify similar items

The data management system uses APIs to train, predict, and score a model for the Recommender System.

In one embodiment, the data management system tracks the progress of training, inference, and/or explanations. The data management system may provide visibility to the end user about the execution status of the data management system's ML operations, for example, how much an operation has progressed, which stages have been completed, any error that has occurred during the operation, and/or whether the operation has been aborted.

Data management system operations such as model training and prediction explanation can take a significant amount of time for large sets of data, depending on the resources applied to train the model. Training incorporates the automation of multiple steps, including pre-processing, row and column selection, hyperparameter optimization, and the final model build. Additionally, the time taken at each stage varies by the data set. Similarly, explaining a prediction may also use significant resources because column values are iteratively substituted to compute each column's importance to the prediction. The progress tracking feature may provide visibility into these machine learning operations. The progress tracker can be invoked on the data management system using SQL queries in a same or different interface than that used to receive the ML queries being tracked.

In one embodiment, the data management system includes an interactive console for MySQL® query processing and ML command processing. The interactive console provides users the ability to manage the database schema objects, run interactive queries, monitor performance, and use machine learning capabilities such that a business analyst can develop applications, manage data objects, use machine learning models, and detect drift of machine learning models. Users can train machine learning models, score, and explain predictions, run predictions and run What-If scenarios to view the impact of feature changes on model outcomes.

In a scenario analysis mode of the user interface, the data management system allows user input to change values of certain features of a data record and compare the model outcome with the original values (aka baseline).

### Compressing the New Data, Reconstructing the New Compressed Data, and Determining a Reconstruction Loss for the New Compressed Data

In one embodiment, reconstruction losses and drift are determined for new data as the data is received, synchronously with the data intake pipeline. In the same or another embodiment, reconstruction losses and drift are updated at the time a machine learning model is asked to make a prediction on a set of data, synchronously with the request pipeline. In either scenario, a drift detector may determine a reconstruction loss and a drift that has occurred since the machine learning model was trained. The drift may be reported along with the prediction results in response to the received request or stored and made available for further analysis of the returned prediction results.

During the training phase, a compression and decompression model was trained on a base set of data to minimize or otherwise mitigate the amount of data lost as the base set of data is compressed and decompressed, leveraging the correlations and combinations that frequently occur in the base set of data to the extent that any exist. This loss mitigation may, for example, minimize an amount of data variance in the base set of data that is unaccounted for in the compressed data. Data drift can be detected when this compression and decompression process is performed on incoming data, whether the incoming data is identified from a machine learning prediction request or as part of an incoming data pipeline. If the incoming data varies in ways that are similar to the base set of data, the loss-mitigated compression and decompression policies trained for the base set of data will similarly mitigate data loss for the incoming data. If the incoming data has drifted from the base set of data, the loss-mitigated compression and decompression policies will likely result in higher data loss than what would have been expected for the base set of data. The higher data loss would be due to differences in data-to-data correlations and dependencies, and value boundaries or extremes, than what occurred for the base set of data. In order to determine how much data loss is occurring for the incoming data, the process of detecting data drift compresses and decompresses incoming data during an inference phase using loss-mitigation policies that were trained for the base set of data.

In one embodiment, a new compressed set of data is generated by compressing a new set of X-dimensional data to Y dimensions using a same or similar model than was used to compress data from the base set of data. A new reconstructed set of data is then generated by decompressing the new compressed set of data back to X dimensions. A new reconstruction loss is determined between the new reconstructed set of data and the new set of data based on differences between the new reconstructed set of data and the new set of data along the X dimensions. The new reconstruction loss is determined in accordance with the techniques described in the previous section, with the new reconstruction loss based on differences between the new reconstructed set of data and the new set of data rather than between the reconstructed set of data and the selected data as performed during the training phase, and may include a reconstruction difference and/or a reconstruction error, in a feature-specific manner and/or an aggregated reconstruction loss over all features.

In one embodiment, the reconstruction loss is determined by applying a mask or weight to feature-specific differences for the set of features, based on weights used in or importance determined for the machine learning model. For example, features that are very different between the input set of data (e.g., the base set of data or the incoming set of data) and the reconstructed version of that set of data may be scaled down if they were included but not highly weighted or of high importance in the machine learning model, relative to other features. As another example, features that are similar between the input set of data and the reconstructed set of data may be scaled up if they were highly weighted or of high importance in the machine learning model, relative to other features. Similarly, features that are already different may be scaled up to be even more different if they were highly weighted or of high importance in the machine learning model, relative to other features. In yet another example, features that are similar between the input set of data and the reconstructed set of data may be scaled down to be even more similar if they were not highly weighted or of high importance in the machine learning model, relative to other features.

In one embodiment, the reconstruction loss determination may exclude certain features that were lowly weighted or of low importance in the machine learning model, relative to other features. In this embodiment, even though certain features may widely vary and even drift after the machine learning model is trained, such features may have been marked as high variance and low importance features that should not be included in the reconstruction loss determination and should not be taken into account in the drift difference or aggregate drift difference determinations.

### Determining a Drift Difference

In one embodiment, a drift detector consumes new samples of data separately and/or in parallel to determine a reconstruction loss for each sample and/or each feature within the sample, and how much drift is attributed to each sample and/or each feature within the sample. The overall reconstruction loss and drift metrics offer a general indication of the sample's drift level, while the feature-specific loss and drift metrics provide detailed insights into where the drift is occurring. Based on the reconstruction loss, the drift detector may determine a drift difference between the reconstruction loss determined during training and the reconstruction loss for a new sample of data. The drift difference may be included in an aggregate drift difference that may include drift differences from other samples, and the aggregate drift difference may be stored in association with the model and/or reported to indicate how far the model has drifted since training.

In one embodiment, the drift detector tracks two drift metrics, an overall drift metric and a feature drift attribution. In one example, the overall drift metric is a non-negative real number assessing the position of the data sample within the distribution of REs for the training data. The overall drift metric indicates the degree of dissimilarity between the production sample and the training samples. The equation below represents an example for how to determine overall drift.

$$overall\_drift \_metric = max ( 0 , \frac{( production\_sample \_RE - training\_drift \_metric \_mean )}{training\_drift \_metric \_std} )$$

In one embodiment, the overall drift metric could be negative if the incoming set of data is more aligned with the reduced dimensionality space than the base set of data. As incoming data streams in, negative values for one subset of incoming values may be summed or averaged with positive values for another subset of incoming values to produce a positive or negative value, depending on whether a larger set of the incoming data is more aligned with the reduced dimensionality space or not.

According to the example definition above, if the overall drift metric is greater than one, then the incoming set of data is varying from the base set of data by more than one standard deviation. If the overall drift metric is greater than two, then the incoming set of data is varying from the base set of data by more than two standard deviations. Depending on the scenario and use case, different thresholds may be applied to the overall drift metric to trigger retraining, depending on a multiple or fraction of a multiple of the standard deviation away drift can be tolerated.

In one embodiment, the drift detector tracks a feature drift metric. The feature drift metric is similar to overall drift metric, but is a vector instead of a number. Each element measures the drift level of the feature at the corresponding position. The equation below represents an example for how to determine a feature drift metric.

$$feature\_drift \_metric = max ( 0 , \frac{production\_sample \_RD - training\_dif \_mean}{training\_diff \_std} )$$

In one embodiment, the drift detector tracks feature drift attribution to give a relative attribution for individual features, such as a percentage or portion of the contribution from an individual feature on the overall drift. In an example, the feature drift attribution is an array with a length matching the number of features. Each element quantifies the drift level of a specific feature in relation to all other features. A high value suggests that the feature has a larger drift compared to others and may be the primary contributor to the overall data drift. The sum of the drift attribution elements equals to 1 in the example equation below.

$${drift\_attribution}_{i} = \frac{feature\_drift {\_metric}_{i}}{{\sum }_{i = 1}^{F} feature\_drift {\_metric}_{i}}$$

$$( F = number of features )$$

In one embodiment, the drift detector detects and distinguishes between different types of drift by tracking additional metrics in association with the tracked drift. For example, the drift detector may track mean, variance, and standard deviation of metrics, and/or correlation between individual metrics. A mean shift type of drift may be detected when the values of one or more dimensions of data increase or decrease over time from the values of the one or more dimensions in training. A variance shift may occur when values tend to vary more or less over time than the values varied in training. A correlation shift may occur when dimensions tend to be more or less correlated with each other over time compared to data correlated or not in the training data.

Drift may also be tracked using other metrics, such as statistical tests Kolmogorov-Smirnov (KS) and/or Population Stability Index (PSI), to additional identify and compare drift metrics. Different drift metrics may be tracked and updated at different frequencies, with lower cost metrics maintained synchronously with incoming data and/or requests and higher cost metrics performed periodically.

### Updating an Aggregate Drift Difference

In one embodiment, the drift difference is included in an aggregate drift difference, which may be stored in association with the machine learning model being measured. The data management system may determine whether to retrain the machine learning model based at least in part on one or more conditions or thresholds that account for the aggregate drift difference.

In one embodiment, individual drift differences may be determined in parallel for a plurality of individual requests, and the aggregate drift difference may be updated transactionally or otherwise logged or appended-to using the individual drift differences determined for the individual requests. In another embodiment, the aggregate drift difference is maintained and updated by a centralized drift detector. The aggregate drift difference may include feature-specific aggregate drift differences and/or an overall aggregate drift difference that covers a plurality of features. In one embodiment, the aggregate drift difference is maintained in the model object catalog. A history of drift differences and/or aggregate drift differences, feature-specific or overall, may be maintained to allow the data management system to determine time-dependent metrics such as a moving average of the aggregate drift, a derivative or rate of change of the aggregate drift, and/or a seasonal pattern in the aggregate drift.

In one embodiment, a moving average of historical drift differences are taken into account for a window of time that includes a most recent N time intervals (e.g., minutes, hours, days, weeks, months, or years) for which drift differences were collected. Drift differences outside the time intervals may be discarded as being too stale to be helpful. This moving average may account for overall drift differences and/or feature-specific drift differences and may be used as the aggregate drift difference.

In the same or another embodiment, a weighted average of historical drift differences are taken into account. The drift differences may be weighted on a variety of factors, including, but not limited to, inverse weighting based on how much time has passed since the drift difference was detected and/or weighting for feature-specific differences based on feature importance in the machine learning model. The weighted average may account for overall drift differences and/or feature-specific drift differences and may be used as the aggregate drift difference.

In a particular example, the drift detector maintains the overall drift metric and feature drift metrics, which may be used together in conditions for determining whether to recommend model retraining based on data drift.

In various examples, by using the compression and decompression techniques described herein, the drift detector may detect drift even when the statistical measures associated with the set of data do not indicate any drift. For example, the mean and variance may remain unchanged, but feature-to-feature dependencies may shift and cause an overall drift.

Tracking drift is relevant to model performance and may indicate that the model has become stale. Beyond reporting on drifted features in the aggregate and separately, the drift detector may also identify, from the model, which features actually are impactful to the model performance. Having large drift in features that do not significantly impact model predictions significantly may be acceptable while having small drift in features that do significantly impact model predictions may be flagged. Distribution of the predictions may also be tracked over time and see if the observed data drift coincides with significant shifts in distributions of model predictions.

### Model Retraining, Model Management Interface, and Other Responsive Action

In one embodiment, the data management system determines whether to retrain the machine learning model based at least in part on one or more conditions that account for the aggregate drift difference. The condition(s) may take into account a threshold of an overall aggregate drift difference, one or more threshold(s) of feature-specific aggregate drift difference(s), trends, derivatives, moving averages, or functions of aggregate drift difference over time, for example, to detect spiking aggregate drift before a threshold is reached, and/or other factors that account for the drift difference or aggregate drift difference. The condition(s) may also account for factors other than the aggregate drift difference, such as how much time has passed since the model was trained, how much workload is expected for the model over the next period of time (e.g., hour, day, week, or month), etc., for example, to prioritize retraining models that have not been recently (e.g., in the past month, quarter, or year) retrained and/or models that have a quiet period of workload that allows for retraining without incurring significant cost.

In one embodiment, the one or more conditions for retraining a model may be learned by a separate machine learning model based on confidence scores of results provided, historical overall and/or feature-specific aggregate drift differences, historical workloads of predictions made by the model(s), other statistical measures of accuracy such as expected prediction distributions or expected data distributions, and/or user feedback on when models are approved for retraining or when a retraining process has been interrupted. For example, the separate machine learning model may learn that the model should be retrained when the overall aggregate drift difference exceeds a first threshold, when a set of particularly impactful features have feature-specific aggregate drift differences that exceed a second threshold (for example, lower than the first threshold and/or higher than the third threshold below), and/or when a set of less impactful features have feature-specific aggregate drift differences that exceed a third threshold (for example, higher than the first threshold and/or the second threshold). This allows more changes and drift to be tolerated for less impactful features and fewer changes and drift to be tolerated for more impactful features. The impact of a feature may be measured as the feature's weight, relative to other features, in making a data prediction by the machine learning model under evaluation.

In one embodiment, even after a decision has been made to retrain a model, the model may remain online for use in processing incoming requests until a retrained model is available for substitution. Once the retrained model is available, the retrained model may be swapped in for the former model to be used in processing requests that are received or processed after the swap time. Confidence scores may be provided for the former model and/or for the retrained model along with results to show users that the lower-confidence model is still in place prior to the swap time and/or that the higher-confidence model is in place after the swap time.

In one embodiment, a data management system determines, from the aggregate drift difference, that the one or more conditions for retraining are not satisfied. Without retraining the machine learning model, the data management system may output a retraining score that indicates how close the one or more conditions are to being satisfied. The retraining score may be expressed in terms of drift observed relative to drift that can be tolerated before retraining, or in any other manner where observed drift and information about the one or more conditions or thresholds are provided. In the same or a different embodiment, the data management system may determine, from the aggregate drift difference, that the one or more conditions are not satisfied, and, without retraining the particular machine learning model, output an aggregate drift difference specific to dimensions of the base set of data. For example, whether or not the conditions for retraining are satisfied, the output may indicate which column(s) contributed most to the drift, which column(s) contributed least to the drift, how much more drift can be tolerated before retraining, and/or how much additional drift has been seen beyond the level where retraining should be triggered.

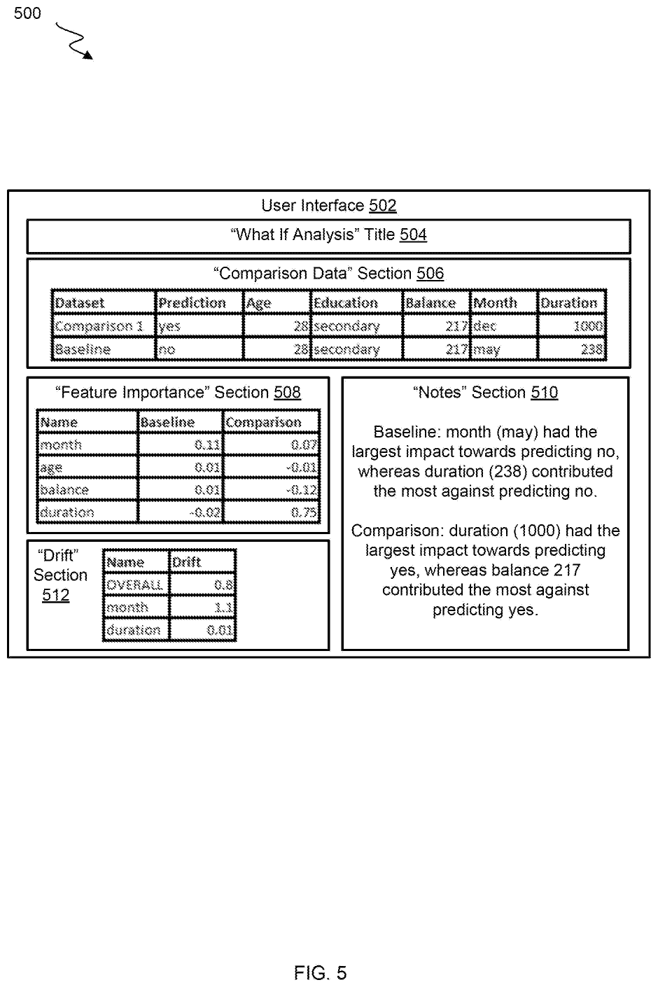

FIG. 5 is an illustration of a user interface 500 for displaying information about predictions and drift. User interface 500 includes a title 504 and example sections 506, 508, and 510 for displaying information about the model or derived from the model. As shown, section 506 includes comparison data for comparing a comparison row to a baseline row. Notes section 510 includes notes about observations about the data. In the example, the notes indicate that, in the baseline data, the month of May had the largest impact towards predicting no, whereas the duration of 238 contributed the most against predicting no. In the comparison data, a duration of 1000 had the largest impact towards predicting yes, and a balance of 217 contributed the most against predicting yes.

The relative importance of features to the model prediction is also shown in feature importance section 508, where month is shown with the highest impact (quantified as 0.11) towards predicting no for the baseline, and duration is shown with the highest impact (quantified as 0.75) towards predicting yes for the comparison. User interface 500 also includes a drift section 512, where information about the most drifted metrics may be displayed. As shown, month has drifted by over a standard deviation from the base set of data, and duration has drifted only slightly from the base set of data. Such a high drift for month data, which is such an impactful feature, may negatively impact performance of the model.

In one embodiment, the data management system maintains information about workload statistics for the data management system and/or for usage of the model. Based on the workload statistics, the data management system may determine a retraining window of a model for which retraining is needed due to aggregate drift metrics or any other retraining condition, or for which retraining is nearing but has not reached a threshold retraining condition yet the retraining window is expected to have historically low workload. For example, the window may occur during a time of low or medium expected workload, or a time of low or medium expected model usage. Because the existing model can be kept in place while a new model is being trained, the overall load on the data management system may be a more definitive factor than a load on the model for determining when to retrain the model when model retraining is otherwise needed due to a retraining condition.

Retraining the model may involve re-performing none, some, or all of the pre-processing steps described herein, including, for example, feature selection. The newly retrained model may include a different number of dimensions, involving overlapping or different columns, than the original model before retraining. The retrained model may use different algorithms and be trained on different training data than the original model before retraining. The training data for the new model may include, for example, some or all of the data for which drift was detected of the original model. Including at least some of this drifted data in the training data of the new model allows the new model to account for the drift that already occurred. The techniques described herein may be reperformed with respect to the new model, triggering additional steps of retraining the model over time as data continues to drift over time.

### Computer System Architecture

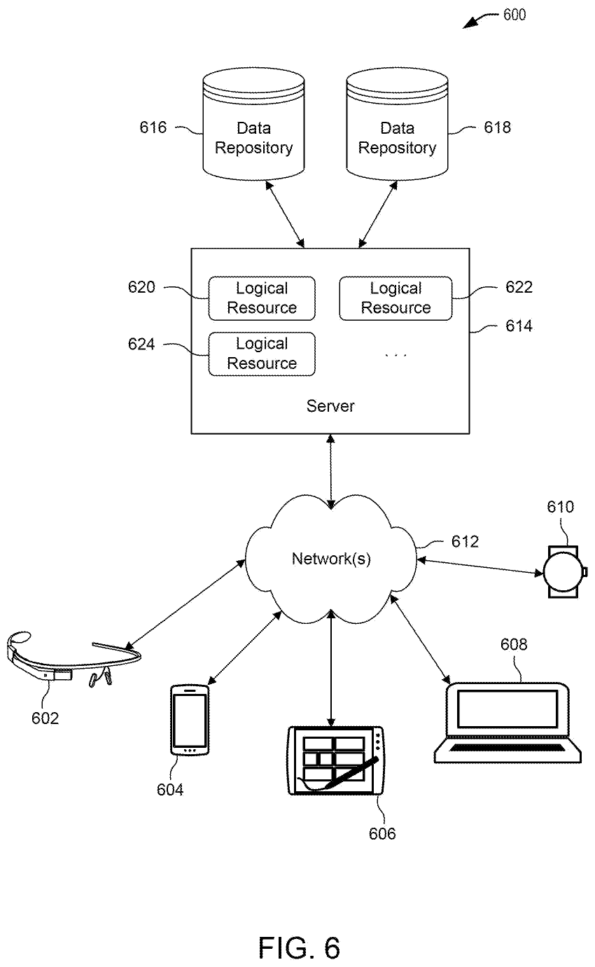

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks 612. Clients computing devices 602, 604, 606, 608, and/or 610 may be configured to execute one or more applications.

In various aspects, server 614 may be adapted to run one or more services or software applications that enable techniques for determining when to retrain machine learning models due to drift.

In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques for determining when to retrain machine learning models due to drift in accordance with the teachings of this disclosure. A client device may provide an interface that enables a user of the client device to interact with the client device. The client device may also output information to the user via this interface. Although FIG. 6 depicts only five client computing devices, any number of client computing devices may be supported.

The client devices may include various types of computing systems such as smart phones or other portable handheld devices, general purpose computers such as personal computers and laptops, workstation computers, smart watches, smart glasses, or other wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, Apple Watch®, Meta Quest®, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 614 may be composed of one or more general purpose computers, specialized server computers (including, by way of example, PC (personal computer) servers, UNIX® servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

Distributed system 600 may also include one or more data repositories 616, 618. These data repositories may be used to store data and other information in certain aspects. For example, one or more of the data repositories 616, 618 may be used to store information for techniques for determining when to retrain machine learning models due to drift. Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, a container database, an Exadata storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

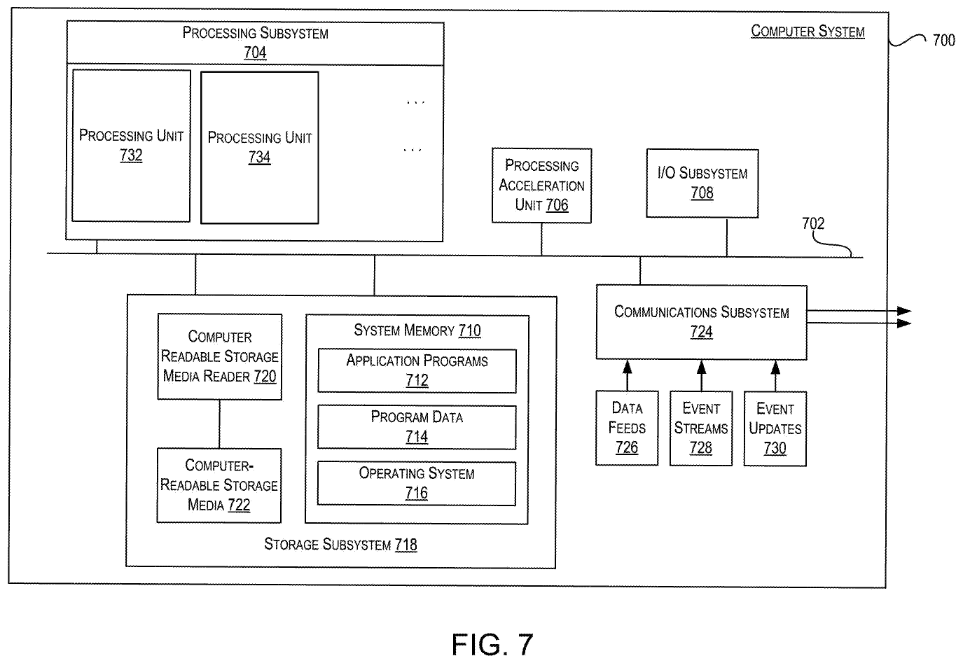

FIG. 7 illustrates an exemplary computer system 700 that may be used to implement certain aspects. For example, in some aspects, computer system 700 may be used to implement any of the system 100 for enriching log records with fields from other log records in structured format as shown in FIG. 1 and various servers and computer systems described above. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may include be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be a cathode ray tube (CRT), a flat-panel device, such as that using a light emitting diode (LED) display, a liquid crystal display (LCD) or plasma display, a projection device, a touch screen, a computer monitor and the like. For example, user interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices. For example, the communication subsystem may be used to transmit a response to a user regarding the inquiry for a Chabot.

Communication subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communication subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
storing a first set of data and a particular machine learning model, wherein the particular machine learning model was trained using at least part of the first set of data to predict one or more values along a first set of dimensions, wherein the first set of data comprises a plurality of combinations of value occurrences in the first set dimensions;
generating a first compressed set of data by compressing particular data from the first set of data to a second set of dimensions, wherein the second set of dimensions has fewer dimensions than the first set of dimensions;
generating a first reconstructed set of data by decompressing the first compressed set of data to the first set of dimensions;
determining a first reconstruction loss between the first reconstructed set of data and the particular data based at least in part on differences between the first reconstructed set of data and the particular data along the first set of dimensions;
using the particular machine learning model to make a prediction for data along the first set of dimensions;
generating a second compressed set of data by compressing a second set of data to the second set of dimensions;
generating a second reconstructed set of data by decompressing the second compressed set of data to the first set of dimensions;
determining a second reconstruction loss between the second reconstructed set of data and the second set of data based at least in part on differences between the second reconstructed set of data and the second set of data along the first set of dimensions;
determining a drift difference between the first reconstruction loss and the second reconstruction loss, and including the drift difference in an aggregate drift difference; and
storing the aggregate drift difference in association with the particular machine learning model, and determining whether to retrain the particular machine learning model based at least in part on one or more conditions that are based at least in part on the aggregate drift difference.

2. The computer-implemented method of claim 1, wherein at least a first dimension of the second set of dimensions comprises a distance from a hyperplane covering a selected combination of value occurrences of the first set of data; and wherein a second dimension of the second set of dimensions is selected to be orthogonal to the first dimension.

3. The computer-implemented method of claim 1, wherein generating the first compressed set of data uses principal component analysis to compress the first set of data, and wherein generating the second compressed set of data uses the principal component analysis to compress the second set of data.

4. The computer-implemented method of claim 1, wherein the second set of dimensions is different from the first set of dimensions, wherein generating the first compressed set of data uses a neural network to compress the first set of data based on one or more feature embedding vectors that describe the first set of data, and wherein generating the second compressed set of data uses the neural network to compress the second set of data based on one or more feature embedding vectors that describe the second set of data.

5. The computer-implemented method of claim 1, wherein each dimension of the second set of dimensions is selected to account for a maximum remaining variance in the first set of data.

6. The computer-implemented method of claim 1, further comprising:
receiving a request to train a machine learning model on the first set of data;
in response to the request, training the particular machine learning model;
wherein performing said generating the first compressed set of data, said generating the first reconstructed set of data, and determining the first reconstruction loss is performed automatically in response to training the particular machine learning model.

7. The computer-implemented method of claim 1, further comprising determining, based at least in part on the aggregate drift difference, that the one or more conditions are not satisfied, and, without retraining the particular machine learning model, outputting a retraining score that indicates how close the one or more conditions are to being satisfied.

8. The computer-implemented method of claim 1, further comprising determining, based at least in part on the aggregate drift difference, that the one or more conditions are not satisfied, and, without retraining the particular machine learning model, outputting an aggregate drift difference specific to one or more of the first set of dimensions.

9. The computer-implemented method of claim 1, further comprising:
determining, based at least in part on the aggregate drift difference, that the one or more conditions are satisfied;
based at least in part on determining that the one or more conditions are satisfied, scheduling a retraining of the particular machine learning model based at least in part on a workload that uses the particular machine learning model; and
retraining the particular machine learning model based at least in part on determining which particular dimensions to include from a superset of dimensions that includes the first set of dimensions and one or more other dimensions.

10. The computer-implemented method of claim 1, wherein at least the step of determining the drift difference between the first reconstruction loss and the second reconstruction loss is performed asynchronously with using the particular machine learning model to make a prediction for data along the first set of dimensions.

11. The computer-implemented method of claim 1, wherein at least the step of determining the drift difference between the first reconstruction loss and the second reconstruction loss is performed in response to a request to use the particular machine learning model to make a prediction for data along the first set of dimensions.

12. A computer-program product comprising one or more non-transitory machine-readable storage media, including stored instructions configured to cause a computing system to perform a set of actions including:
storing a first set of data and a particular machine learning model, wherein the particular machine learning model was trained using at least part of the first set of data to predict one or more values along a first set of dimensions, wherein the first set of data comprises a plurality of combinations of value occurrences in the first set dimensions;
generating a first compressed set of data by compressing particular data from the first set of data to a second set of dimensions, wherein the second set of dimensions has fewer dimensions than the first set of dimensions;
generating a first reconstructed set of data by decompressing the first compressed set of data to the first set of dimensions;
determining a first reconstruction loss between the first reconstructed set of data and the particular data based at least in part on differences between the first reconstructed set of data and the particular data along the first set of dimensions;
using the particular machine learning model to make a prediction for data along the first set of dimensions;
generating a second compressed set of data by compressing a second set of data to the second set of dimensions;
generating a second reconstructed set of data by decompressing the second compressed set of data to the first set of dimensions;
determining a second reconstruction loss between the second reconstructed set of data and the second set of data based at least in part on differences between the second reconstructed set of data and the second set of data along the first set of dimensions;
determining a drift difference between the first reconstruction loss and the second reconstruction loss, and including the drift difference in an aggregate drift difference; and
storing the aggregate drift difference in association with the particular machine learning model, and determining whether to retrain the particular machine learning model based at least in part on one or more conditions that are based at least in part on the aggregate drift difference.

13. The computer-program product of claim 12, wherein at least a first dimension of the second set of dimensions comprises a distance from a hyperplane covering a selected combination of value occurrences of the first set of data; and wherein a second dimension of the second set of dimensions is selected to be orthogonal to the first dimension.

14. The computer-program product of claim 12, wherein generating the first compressed set of data uses principal component analysis to compress the first set of data, and wherein generating the second compressed set of data uses the principal component analysis to compress the second set of data.

15. The computer-program product of claim 12, wherein the second set of dimensions is different from the first set of dimensions, wherein generating the first compressed set of data uses a neural network to compress the first set of data based on one or more feature embedding vectors that describe the first set of data, and wherein generating the second compressed set of data uses the neural network to compress the second set of data based on one or more feature embedding vectors that describe the second set of data.

16. The computer-program product of claim 12, wherein the set of actions further includes:
receiving a request to train a machine learning model on the first set of data;
in response to the request, training the particular machine learning model;
wherein performing said generating the first compressed set of data, said generating the first reconstructed set of data, and determining the first reconstruction loss is performed automatically in response to training the particular machine learning model.

17. The computer-program product of claim 12, wherein the set of actions further includes:
determining, based at least in part on the aggregate drift difference, that the one or more conditions are not satisfied, and, without retraining the particular machine learning model, outputting an aggregate drift difference specific to one or more of the first set of dimensions.

18. A system comprising:
one or more processors;
one or more non-transitory computer-readable media storing instructions, which, when executed by the system, cause the system to perform a set of actions including:
storing a first set of data and a particular machine learning model, wherein the particular machine learning model was trained using at least part of the first set of data to predict one or more values along a first set of dimensions, wherein the first set of data comprises a plurality of combinations of value occurrences in the first set dimensions;
generating a first compressed set of data by compressing particular data from the first set of data to a second set of dimensions, wherein the second set of dimensions has fewer dimensions than the first set of dimensions;
generating a first reconstructed set of data by decompressing the first compressed set of data to the first set of dimensions;
determining a first reconstruction loss between the first reconstructed set of data and the particular data based at least in part on differences between the first reconstructed set of data and the particular data along the first set of dimensions;
using the particular machine learning model to make a prediction for data along the first set of dimensions;
generating a second compressed set of data by compressing a second set of data to the second set of dimensions;
generating a second reconstructed set of data by decompressing the second compressed set of data to the first set of dimensions;
determining a second reconstruction loss between the second reconstructed set of data and the second set of data based at least in part on differences between the second reconstructed set of data and the second set of data along the first set of dimensions;
determining a drift difference between the first reconstruction loss and the second reconstruction loss, and including the drift difference in an aggregate drift difference; and
storing the aggregate drift difference in association with the particular machine learning model, and determining whether to retrain the particular machine learning model based at least in part on one or more conditions that are based at least in part on the aggregate drift difference.

19. The system of claim 18, wherein at least a first dimension of the second set of dimensions comprises a distance from a hyperplane covering a selected combination of value occurrences of the first set of data; and wherein a second dimension of the second set of dimensions is selected to be orthogonal to the first dimension.

20. The system of claim 18 wherein generating the first compressed set of data uses principal component analysis to compress the first set of data, and wherein generating the second compressed set of data uses the principal component analysis to compress the second set of data.

21. The system of claim 18, wherein the second set of dimensions is different from the first set of dimensions, wherein generating the first compressed set of data uses a neural network to compress the first set of data based on one or more feature embedding vectors that describe the first set of data, and wherein generating the second compressed set of data uses the neural network to compress the second set of data based on one or more feature embedding vectors that describe the second set of data.

22. The system of claim 18, wherein the set of actions further includes:
determining, based at least in part on the aggregate drift difference, that the one or more conditions are not satisfied, and, without retraining the particular machine learning model, outputting an aggregate drift difference specific to one or more of the first set of dimensions.
